(19) United States
(12) Patent Application Publication
(10) Pub. No.: US 2025/0042696 A1
(43) Pub. Date: Feb. 6, 2025

(54) ELEVATOR CAR, ELEVATOR SYSTEM AND A METHOD OF PROVIDING ACCESS TO AN AREA OUTSIDE AN ELEVATOR CAR

(71) Applicant: OTIS ELEVATOR COMPANY, Farmington, CT (US)

(72) Inventors: Aurélien Fauconnet, ISDES (FR); Frédéric Beauchaud, Coullons (FR)

(21) Appl. No.: 18/746,396

(22) Filed: Jun. 18, 2024

(30) Foreign Application Priority Data
Aug. 3, 2023 (EP) 23306329.6

(51) Int. Cl. B66B 11/02; B66B 5/00

(52) U.S. Cl. CPC B66B 11/0246; B66B 5/005; B66B 11/0253

(57) ABSTRACT

An elevator car comprises a panel that is moveable between a closed position, in which the panel at least partially defines a sidewall of the elevator car, and an open position, in which an opening is provided in the sidewall to an area outside of the elevator car. A member is provided external to the sidewall and extends across at least a portion of the sidewall such that, when the panel is in the open position, the opening is spanned by the member. A mechanism is on one of the panel and the member. The mechanism is moveable between a first position, in which the mechanism is not engaged with the other one of the panel and the member, and a second position, in which the mechanism is engaged with the other one of the panel and the member such that the panel is held in the closed position.

### CROSS-REFERENCE TO RELATED APPLICATION

This application is a U.S. non-provisional application claiming the benefit of European Application No. 23306329.6, filed on Aug. 3, 2023, which is incorporated herein by reference in its entirety.

### TECHNICAL FIELD

The disclosure relates to an elevator car; to an elevator system comprising an elevator car; and to a method of providing access to an area outside an elevator car.

### BACKGROUND

Elevator systems require regular checks, maintenance, and repairs. In order to assess the operating condition of the elevator system and to ensure it is fit for purpose, it is required to access component parts of the elevator system located in the elevator hoistway. To do so maintenance personnel typically enters the hoistway above or below the elevator car. There are numerous difficulties and safety risks associated with this.

Developments in the design of elevator systems have made it possible for maintenance personnel to gain access to certain component parts located in the hoistway or on the outside of the elevator car from within the elevator car itself. This significantly improves the safety of the maintenance personnel involved. One way of achieving this is by providing openable or removable car panels to provide an opening to an area outside of the elevator car. While there is no need for the maintenance personnel to enter the hoistway in this scenario, there are further safety risks that need to be addressed to reduce the risk of injury and to improve fall prevention.

### SUMMARY

According to a first aspect of the disclosure, there is provided an elevator car. The elevator car comprises a panel moveable between a closed position, in which the panel at least partially defines a sidewall of the elevator car, and an open position, in which an opening is provided in the sidewall to an area outside of the elevator car; a member provided external to the sidewall and extending across at least a portion of the sidewall such that, when the panel is in the open position, the opening provided in the sidewall is spanned by the member; and a mechanism provided on one of the panel and the member, wherein the mechanism is configured to be moveable between a first position, in which the mechanism is not engaged with the other one of the panel and the member or a component attached to the other one of the panel and the member, and a second position, in which the mechanism is engaged with the other one of the panel and the member or the component attached to the other one of the panel and the member such that the panel is held in the closed position.

It will be understood that the member according to the disclosure is configured to ensure the safety of maintenance personnel when accessing an area outside of the elevator car. In some examples, the member may be configured to stop maintenance personnel falling from the elevator car when accessing the area outside of the elevator car.

In examples, the member may be designed in consideration with a particular safety concern or need. As a result, the member could take various forms and configurations. In any example, the member could be formed of metal, for example steel or aluminium. In some examples, the member could comprise any one of a rail, a handrail and a kickplate or may be configured as part of a balustrade. In some examples, the member may be provided proximate a floor of the elevator car.

It will further be appreciated that the elevator car may comprise any number of additional members. In any example, the elevator car may comprise at least one additional member. The at least one additional member could be configured in a similar manner to the member or could take a different form and configuration. The at least one additional member could comprise any one of a rail, a handrail and a kickplate or may be configured as part of a balustrade. The at least one additional member may be configured to stop maintenance personnel falling from the elevator car when accessing the area outside of the elevator car. The at least one additional member may be provided proximate a floor of the elevator car. It will be appreciated that the number and configuration of any additional members may be selected in consideration to various safety requirements and regulations.

The mechanism could engage with the other one of the panel and the member directly. This may allow for a straightforward way to secure the panel in the closed position and may reduce the need for further components. In some examples, the mechanism may be provided on the panel such that in the second position the mechanism is engaged with the member. In other examples, the mechanism may be provided on the member such that in the second position the mechanism is engaged with the panel.

In examples, the mechanism could instead engage with the other one of the panel and the member via a component attached to the other one of the panel and the member. This may allow for a more straightforward panel design and/or manufacture. In some examples, the mechanism may be provided on the panel such that in the second position the mechanism is engaged with the component attached to the member. In other example, the mechanism may be provided on the member such that in the second position the mechanism is engaged with the component attached to the panel.

The component could take various form and configurations. For example, the component may comprise a fixture. In examples, the component may be configured to interlock with the mechanism. In some examples, the component may be one of an eyelet or a hoop for engagement with the mechanism.

The mechanism could take various forms and configurations. In some examples, the mechanism may comprise at least one of a hook or a latch configured to fasten the member and the panel to one another when the mechanism is in the second position. In some examples, the mechanism may be configured to pivot between the first position and the second position. In other examples, the mechanism may instead be moved linearly or slideably.

The mechanism may allow maintenance personnel to safely move the panel between the closed and open positions and may prevent unintended movement of the panel when the panel is in the closed position and the mechanism is in the second position. It will be understood that the panel may be configured to move unrestricted between the closed and open positions when the mechanism is in the first position. In some examples, the mechanism may be moveable manually between the first position and the second position. In any example, the mechanism may alternatively or additionally be configured to be moved automatically between the first position and the second position. For example, the mechanism may be moved via one or more actuators. It will be appreciated that the mechanism may be configured and/or positioned such that it cannot be accessed by passengers in the elevator car during the normal operation of an elevator system.

In any example, the elevator car may comprise a single panel or any number of panels moveable between a closed and an open position. In any example described above, the panel of the elevator car could be a first panel and the opening could be a first opening. In such examples, the elevator car may further comprise a second panel moveable between a closed position, in which the second panel at least partially defines the sidewall of the elevator car, and an open position, in which a second opening is provided in the sidewall to the area outside of the elevator car. This may allow for a wider access window to be provided to the area outside of the elevator car and may facilitate the installation of the sidewall of the elevator car. The provision of additional panels may further allow for different access windows to be provided to the area outside the elevator car at different stages of the maintenance operations. The provision of a second panel could allow, in examples, access from inside of the elevator car to the mechanism to be provided when the second panel is in the open position.

It will be appreciated that the elevator car could comprise any number of additional safety features. For example, the elevator car could comprise any number of auxiliary mechanisms configured to secure the first panel in the closed position. The elevator car could comprise a single auxiliary mechanism. The provision of auxiliary mechanisms may prevent the sudden opening of the first and the second panel at the same time, which may pose various safety risks to any maintenance personnel in the elevator car. The provision of auxiliary mechanisms may thus allow for a controlled opening of the first panel in examples comprising more than one panels. In examples, the auxiliary mechanism could take various forms and configurations. The auxiliary mechanism may be configured to secure the first panel to at least one of a floor or a ceiling of the elevator car. The auxiliary mechanism may comprise at least one of a door bolt or a latch.

In examples, the elevator car may further comprise an interpanel mechanism configured to secure the first panel to the second panel when both the first and the second panels are in the closed position. The interpanel mechanism may prevent unauthorised or unintended access to the area outside of the elevator car. The interpanel mechanism may also allow for the reduction of features necessary to hold the second panel in the closed position as the second panel only need be secured to the first panel.

In any example, the elevator car could comprise a control panel provided inside the elevator car. The control panel of the elevator car could comprise a first passenger facing side and a second opposite side, wherein the control panel may be integrated within one of the first panel and the second panel such that when said first or second panel is in the open position, access is provided to the second opposite side of the control panel. This could facilitate maintenance operations carried out on the control panel as operations can be carried out by maintenance personnel inside the elevator car.

According to an aspect, there is provided an elevator system comprising an elevator car as described above. It will be understood that the elevator car described above is suitable for use in various elevator systems. For example, the elevator system could be a roped or a ropeless elevator system. In any examples, the elevator system may comprise one or more of a guide rail, a counterweight, a tension member, a position reference system, and a controller. The elevator system may include a hoistway within which the elevator car operates.

According to an aspect, there is provided a method of providing access to an area outside an elevator car as described above, wherein the method includes: operating the mechanism to move it from the second position to the first position; and moving the panel from the closed position to the open position to provide the opening via which component parts located outside the elevator car may be accessed from inside of the elevator car.

In examples, the panel may be a first panel and the opening may be a first opening, and the elevator car may further comprise a second panel moveable between a closed position, in which the second panel at least partially defines the sidewall of the elevator car, and an open position, in which a second opening is provided in the sidewall to the area outside of the elevator car. The method may further comprise: before operating the mechanism, moving the second panel to the open position.

Operating the mechanism may comprise accessing the mechanism via the second opening to manually move the mechanism from the second position to the first position.

### BRIEF DESCRIPTION OF DRAWINGS

FIG. 1 is a schematic illustration of an elevator system that may employ various examples of the present disclosure;

FIG. 2 is a schematic view of an elevator car according to an example of the present disclosure with a panel thereof in a closed position;

FIG. 3 is a schematic view of the elevator car of FIG. 2 with the panel thereof in an open position;

FIG. 4 is a schematic view of a panel of an elevator car as viewed from inside of the elevator car according to an example of the present disclosure and when in the closed position;

FIG. 5 is a schematic view of the panel of the elevator car of FIG. 4 when in the open position;

FIG. 6 is a close-up schematic view of a mechanism of an elevator car according to an example of the present disclosure in a first position;

FIG. 7 is a close-up schematic view of the mechanism of FIG. 6 in a second position;

FIG. 8 is a close-up schematic view of a part of the elevator car according to an example of the present disclosure; and

FIG. 9 is a schematic of an auxiliary mechanism according to an example of the present disclosure.

### DETAILED DESCRIPTION

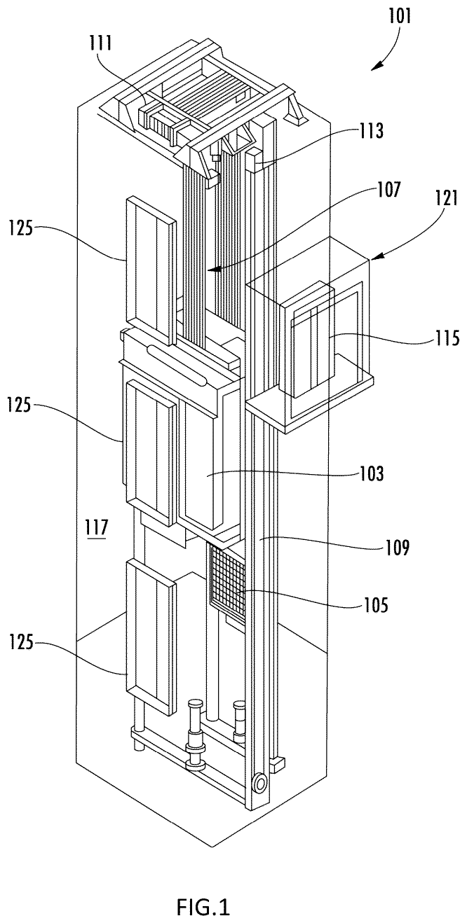

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving part of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, levelling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other component parts, is supplied to the motor. The machine 111 may include a traction sheave that imparts force to tension member 107 to move the elevator car 103 within elevator hoistway 117.

Although shown and described with a roping system including a tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

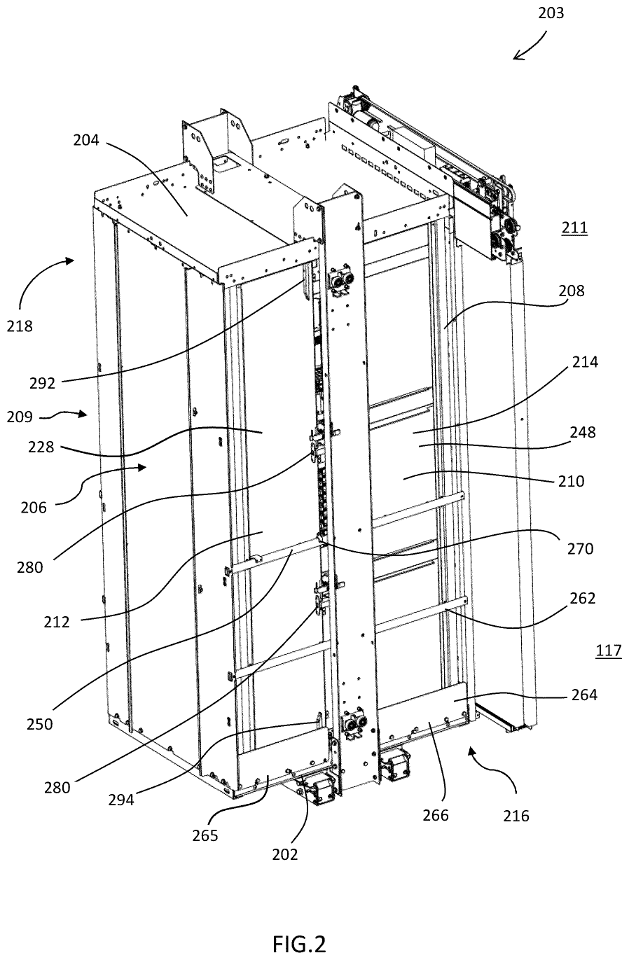

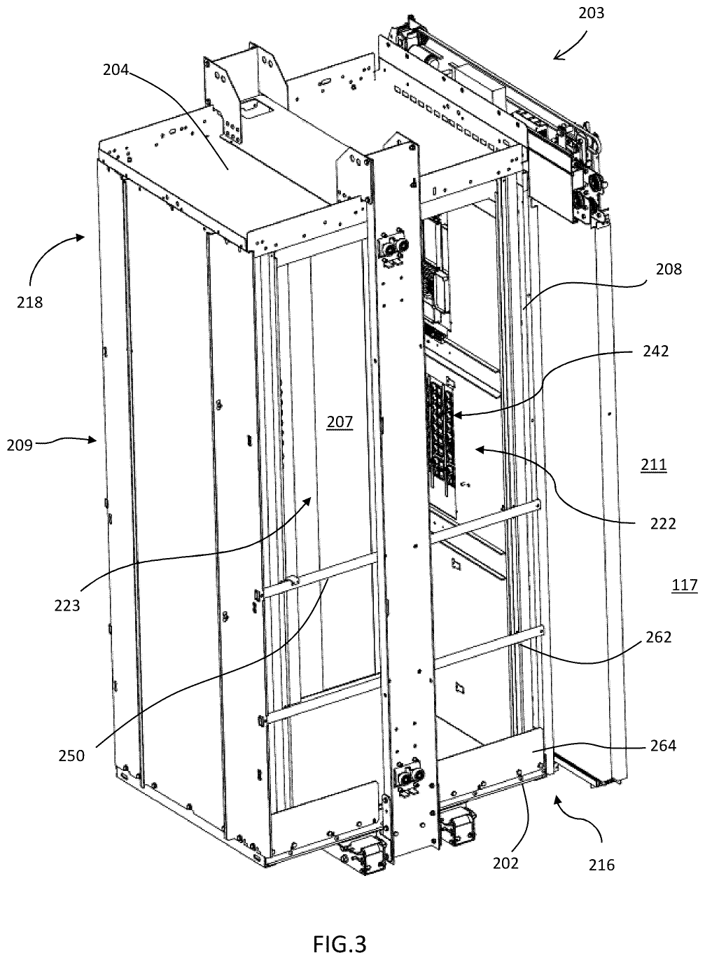

FIG. 2 and FIG. 3 show a schematic perspective view of an elevator car 203 for use in an elevator system such as the elevator system 101 described above. The elevator car 203 comprises a floor 202 and a ceiling 204. A plurality of sidewalls 206 extend between the floor 202 and the ceiling 204. The floor 202, the ceiling 204 and the plurality of sidewalls 206 delimit an inside 207 of the elevator car 203. The inside 207 of the elevator car 203 may comprise a passenger compartment for the transportation of passengers between landings (for example the landings 125 of the elevator system 101 described above). The inside 207 may comprise an enclosed space. One or more of the plurality of sidewalls 206 may comprise a car door (not shown). The car door may provide access to the inside 207 of the elevator car 203 for the boarding of passengers when the elevator car 203 is stopped at the one or more landings 125.

An outside 209 of the elevator car 203 may be defined by the exterior of the elevator car 203. Various component parts of the elevator car 203 may be provided on the outside 209 of the elevator car 203. For example, component parts provided on the outside 209 of the elevator car 203 may include a safety brake (not shown) and/or one or more sensors (not shown) for detecting the position of the elevator car 203. Component parts provided on the outside 209 of the elevator car 203 may not be accessible from the inside 207 of the elevator car 203 during normal operation of the elevator system 101. Component parts provided on the outside 209 of the elevator car 203 may be exposed to the hoistway 117 of the elevator system 101. The elevator car 203 may further comprise a front side 218 and a rear side 216. Each of the front side 218 and the rear side 216 may be defined by one of the plurality of sidewalls 206. The rear side 216 may be opposite the front side 218. The car door may be provided at the front side 218.

The elevator car 203 may comprise an elevator car frame 208. The elevator car frame 208 may support the floor 202, the ceiling 204 and the plurality of sidewalls 206 of the elevator car 203. The floor 202, the ceiling 204 and the plurality of sidewalls 206 of the elevator car 203 may be mounted onto the elevator car frame 208. Component parts provided on the outside 209 of the elevator car 203 may be installed on or attached to the elevator car frame 208. Each sidewall of the plurality of sidewalls 206 may be defined by at least one panel mounted onto the elevator car frame 208.

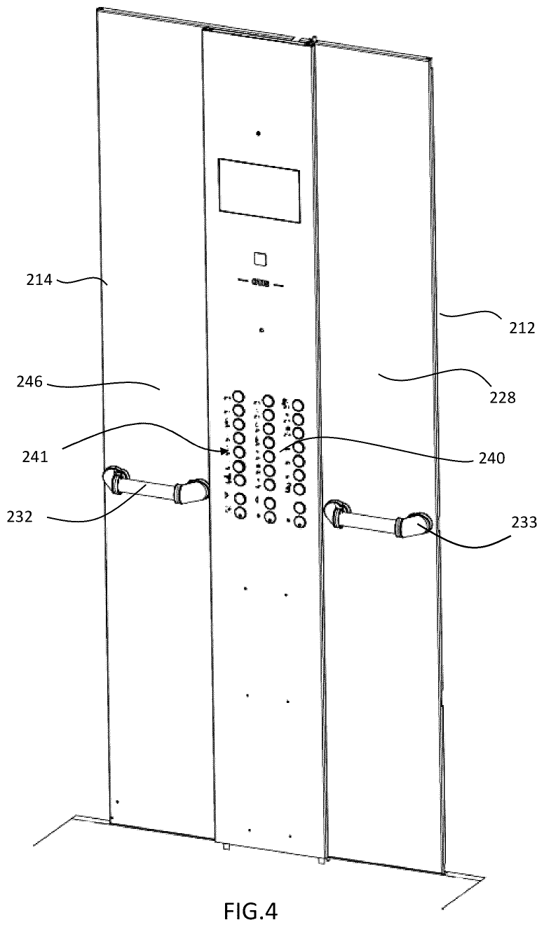

In any example, the elevator car 203 comprises at least one panel moveable between a closed position and an open position. The panel at least partially defines one of the plurality of sidewalls 206 of the elevator car 203 when in the closed position. The panel provides an opening to an area 211 outside of the elevator car 203 when occupying the open position. In the example of FIG. 2 and FIG. 3, the elevator car 203 comprises a first panel 212. FIG. 2 shows the elevator car 203 with the first panel 212 in the closed position. FIG. 3 shows the elevator car 203 with the first panel 212 in the open position. FIG. 4 and FIG. 5 are schematic views showing the first panel 212 as viewed from the inside 207 of the elevator car 203 in the closed and open positions respectively. Various elements of the elevator car 203 have been omitted from FIG. 4 and FIG. 5 in order to show an unobstructed view of the first panel 212.

With continuous reference to FIG. 2 and FIG. 3, the first panel 212 defines a portion of a sidewall 210 of the elevator car 203. The sidewall 210 may be at the rear side 216 of the elevator car 203. The sidewall 210 may be defined by a plurality of panels. The plurality of panels may include the first panel 212 and any number of additional panels. The additional panels may be permanently or semi-permanently attached to the elevator car 203. The additional panels may include any number of further moveable panels, such as a second panel 214. The first panel 212 may be flush, or substantially flush, with the sidewall 210 (and any additional panels defining the sidewall 210).

The first panel 212 may be flat or substantially flat. The first panel 212 may be defined by an internal side 226 and an external side 228. The internal side 226 may face the inside 207 of the elevator car 203 when the first panel 212 is in the closed position. The external side 228 may face the hoistway 117 of the elevator system 101 when the first panel 212 is in the closed position. The internal side 226 may define, at least partially, the inside 207 of the elevator car 203 when the first panel 212 is in the closed position. The external side 228 may define, at least partially, the outside 209 of the elevator car 203 when the first panel 212 is in the closed position.

The first panel 212 may be mounted to the elevator car frame 208. The first panel 212 may extend between the floor 202 and the ceiling 204 of the elevator car 203. The first panel 212 may define the entire height of the sidewall 210.

The first panel 212 may comprise a handrail 232. The handrail 232 may be attached to the internal side 226 of the first panel 212. The handrail 232 may be used by a passenger during normal operation of the elevator system 101 to hold onto. The handrail 232 may also be used by maintenance personnel as a leverage to open the first panel 212 during maintenance operations. It will be understood that “opening” the first panel 212 refers to moving the first panel 212 from the closed position to the open position. At the same time, moving the first panel 212 from the open position to the closed position may be referred to as “closing” the first panel 212.

The first panel 212 may open towards the inside 207 of the elevator car 203 as shown in the example of FIG. 5. In the example shown, the first panel 212 is pivotably mounted to the elevator car 203. The first panel 212 may be attached to the elevator car 203 via one or more hinges (not shown). In other examples, the first panel 212 may slide between the open and the closed position. In examples, the first panel 212 may be mounted to the elevator car 203 via a scissor mechanism.

In any example, the first panel 212 is moveable from the closed position to the open position so as to provide a first opening 222 in the sidewall 210 to an area 211 outside of the elevator car 203. It will be understood that when in use in an elevator system, the area 211 outside of the elevator car 203 may be located in the hoistway of the elevator system. The opening 222 may be provided at the rear side 216 of the elevator car 203. The area 211 outside of the elevator car 203 may include an area in which the tension member 107 is connected to the elevator car 203 or an area comprising the guide rail 109. The first opening 222 may be configured to provide access to component parts located on the outside 209 of the elevator car 203, such as a safety break, a governor, a speed and/or position sensor or any other component part provided at the rear side 216, top side or bottom side of the elevator car 203. It will be appreciated that the first opening 222 allows maintenance personnel to gain access to the area 211 outside of the elevator car or to a component part provided on the outside 209 of the elevator car 203 from the inside 207 of the elevator car 103 without entering the hoistway 117 of the elevator system 101. This allows for component parts of the elevator system 101 located in the area 211 to be checked, maintained and/or repaired more easily. It further reduces the safety risks associated with maintenance personnel entering the hoistway 117, for example by climbing above or below the elevator car 203.

The first opening 222 may be dimensioned to provide a sufficiently large access window to the area 211 outside of the elevator car 203 for checks, maintenance and repairs to be carried out. This improves the ease of access but also increases the risk of falls. There is a need to improve the safety of maintenance personnel during checks, maintenance and repairs of the elevator system 101 when such operations are carried out from the inside 207 of the elevator car 203.

The elevator car 203 comprises at least one member 250. The member 250 is provided external to the sidewall 210 of the elevator car 203. In other words, the member 250 is provided on the outside 209 of the elevator car 203. The member 250 may be fixed to any suitable part of the elevator car 203. The member 250 may be fixed to any suitable part of the elevator car 203 at a first and/or a second axial end (not shown) thereof. The member 250 may be fixed to the elevator car frame 208. The member 250 may be provided at the rear side 216 of the elevator car 203.

The member 250 extends across at least a portion of the sidewall 210. When the first panel 212 is in the open position, the member 250 extends across the first opening 222, provided by the first panel 212 in the sidewall 210. In other words, the opening 222 is spanned by the member 250. The member 250 may span the entire width of the sidewall 210. The member 250 may be located between the inside 207 of the elevator car 203 and the area 211 outside of the elevator car 203 to which access is provided via the first opening 222.

In the example shown, the member 250 is provided at a height suitable to stop maintenance personnel falling from the elevator car 203 when accessing the area 211 outside of the elevator car 203. The member 250 may be provided at a height equal to about 40% to 60% of the height of the elevator car 203. The height of the elevator car being defined as the distance between the floor 202 and the ceiling 204. The member 250 may comprise a rod or a bar. The member 250 may be configured as a handrail or may be part of a balustrade. The member 250 may be arranged so as to restrict unintended movement through the opening 222.

In other examples, the member 250 may be provided proximate the floor of the elevator car 203. The member 250 may comprise a kickplate. The kickplate may comprise a plate. The kickplate may extend upwards from the floor 202 of the elevator car 203. The kickplate may be secured to the floor 202 of the elevator car 203 via one or more fasteners, for example via one or more screws. The kickplate may be configured to stop maintenance personnel falling from the elevator car 203 and/or to prevent tools and other objects from rolling off the floor of the elevator car 203 into the hoistway 117.

In the example shown, the member 250 comprises a single part. The member 250 may extend continuously across the sidewall 210. In examples, the member 250 may instead comprise a number of segments. The segments of the member 250 may be arranged in series across the sidewall 210. The segments of the member 250 may be arranged around other component parts of the elevator car 203 that would have prevented the member 250 from extending continuously. In these examples, each segment of the member 250 may be fixed to any suitable part of the elevator car 203 at a first and/or a second axial end (not shown) thereof.

The elevator car 203 may comprise a number of additional members. In the example shown, the elevator car 203 comprises a first additional member 262 and a second additional member 264. The first additional member 262 may not have the same configuration and/or dimensions as the second additional member 264. The first additional member 262 may be provided spaced apart from the member 250. The first additional member 262 may extend parallel to the member 250. The first additional member 262 may span across the first opening 222. The first additional member 262 may be configured to have identical, or substantially similar, features to the member 250 and as such a detailed description is omitted.

The second additional member 264 may comprise a kickplate. In the example shown, the second additional member 264 is formed by a first segment 265 and a second segment 266.

The member 250 may not be accessible from inside 207 of the elevator car 203 during normal operation of the elevator system 101. Access to the member 250 may be provided by moving the first panel 212 to the open position.

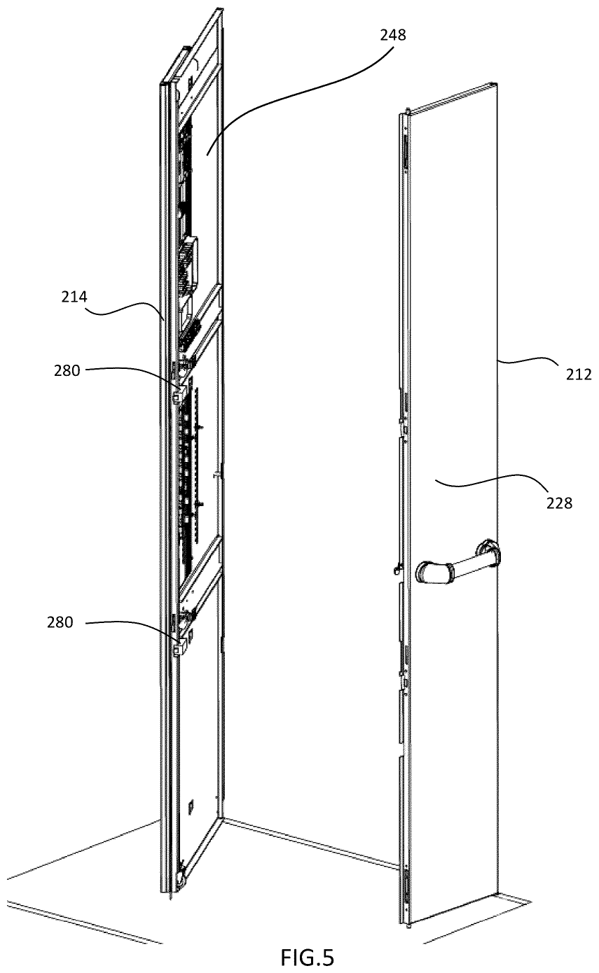

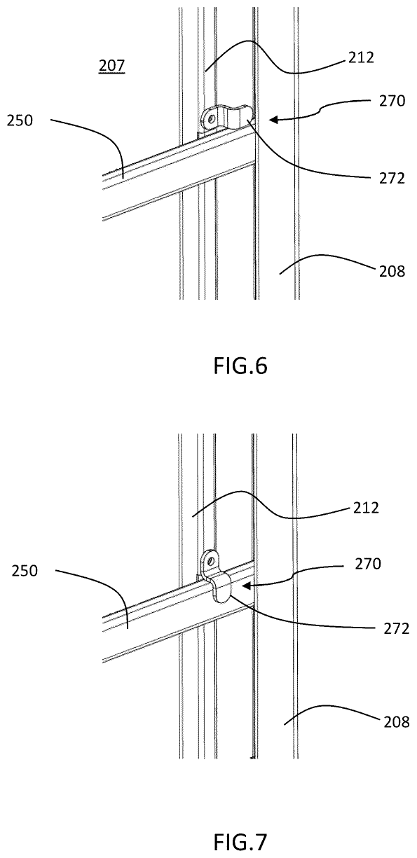

During normal operation of the elevator system 101, the first panel 212 may be secured in the closed position by a mechanism 270 to ensure passenger safety. The mechanism 270 may be a locking mechanism. The mechanism 270 may be provided external to the sidewall 210. The mechanism 270 may be provided on the outside 209 of the elevator car 203. The mechanism 270 is moveable between a first position and a second position. The mechanism 270 is configured to stop movement of the first panel 212 from the closed position to the open position when the mechanism 270 is in the second position. FIG. 6 and FIG. 7 are close-up views of aa part of the elevator car 203 of FIG. 2 and FIG. 3, showing the mechanism 270 in the first position and the second position respectively.

When the mechanism 270 is in the first position, the member 250 and the first panel 212 are not in engagement with one another. When the mechanism 270 is in the second position, the member 250 and the first panel 212 are in engagement with one another such that movement of the first panel 212 in relation to the member 250 is prevented. In this regard, inadvertent or unauthorised opening of the first panel 212 is prevented when the mechanism 270 is in the second position. The mechanism 270 may be configured to fasten the member 250 and the first panel 212 to one another when in the second position.

The mechanism 270 is provided on one of the first panel 212 and the member 250. In the example shown, the mechanism 270 is provided on the first panel 212 such that, when the mechanism 270 is the first position, the mechanism 270 is not engaged with the member 250 and such that, when the mechanism 270 is the second position, the mechanism 270 is engaged with the member 250. The mechanism 270 may be fixed to the first panel 212. In other examples, the mechanism 270 may be provided on the member 250 such that, when the mechanism 270 is the first position, the mechanism 270 is not engaged with the first panel 212 and such that, when the mechanism 270 is the second position, the mechanism 270 is engaged with the first panel 212.

In examples, a component (not shown) for engaging with the mechanism 270 may be provided. In examples where the mechanism 270 is provided on the first panel 212, the component may be provided on the member 250. In examples where the mechanism 270 is provided on the member 250, the component may be provided on the first panel 212 instead. The component may be configured to interlock with the mechanism 270, or part thereof. In examples, the component may comprise a fixture or a mechanism.

In examples where the mechanism 270 is provided on the first panel 212, the component may be fixed to the member 250. When the mechanism 270 is in the first position, the mechanism 270 and the component may not be engaged with one another. As a result, the mechanism 270 may not engage the member 250. When the mechanism 270 is in the second position, the mechanism 270 and the component may interlock with one another. As a result, the mechanism 270 may engage the member 250 via the component such that movement of the first panel 212 relative to the member 250 is prevented.

In the example shown, the mechanism 270 comprises a hook 272. The hook 272 may be provided on the first panel 212. The hook 272 may be pivotably attached to the first panel 212. The hook 272 may pivot between the first and second positions. In the first position, the hook 272 may be stored away from the member 250. In the second position, the hook 272 may engage the member 250. The hook 272 may be configured to catch hold of the member 250. In examples, where the mechanism 270 comprises the hook 272 and wherein a component for engagement with the mechanism 270 is provided on the member 250, the component may comprise a hoop or an eye for engagement with the mechanism 270.

It will be appreciated that the hook 272 may be provided on the member 250 instead. In such case, the hook 272 may be stored away from the first panel 212 in the first position and may catch hold of the first panel 212 in the second position. The first panel 212 may comprise a protrusion configured to engage the hook 272 in the second position. The protrusion may be provided as an integral feature of the first panel 212 or may be otherwise attached to the first panel 212.

In examples, the mechanism 270 may comprise other types of mechanical fasteners. For example, the mechanism 270 may comprise a latch or a cam mechanism. In examples, the mechanism 270 may be slideably moveable between the first and second positions. In examples, the mechanism 270 may be rotatably moveable between the first and the second positions.

In the examples shown, the mechanism 270 is configured to be operated manually. In other words, the mechanism 270 may be moveable between the first and second positions by maintenance personnel using their hands or a tool such as a screwdriver. In examples, the mechanism 270 may be remotely moveable via one or more actuators. In examples, the mechanism 270 may be moveable from inside 207 of the elevator car 203 via an access slot. In such examples moving the mechanism 270 between positions may require a tool or a key configured to be received by or through the access slot.

In the example shown, the sidewall 210 further comprises a second panel 214. The second panel 214 may be moveable between a closed position and an open position. The second panel 214 may define a portion of the sidewall 210. The portion of the sidewall 210 defined by the second panel 214 may be different to the portion defined by the first panel 212.

The second panel 214 may be flat or substantially flat. The second panel 214 may be defined by an internal side 246 and an external side 248. The internal side 246 may face the inside 207 of the elevator car 203 when the second panel 214 is in the closed position. The external side 248 may face the hoistway 117 of the elevator system 101 when the second panel 214 is in the closed position. The external side 248 may define, at least partially, the outside 209 of the elevator car 203 when the second panel 214 is in the closed position.

The second panel 214 may be mounted to the elevator car frame 208. The second panel 214 may extend between the floor 202 and the ceiling 204 of the elevator car 203. The second panel 214 may define the height of the sidewall 210. The second panel 214 may be sized to be of similar dimensions to the first panel 212. The first and second panels 212, 214 may differ in at least one aspect, such as height or width.

The second panel 214 may include a handrail 233. The handrail 233 may be attached to the second panel 214. The handrail 233 may be attached to an internal side 226 of the second panel 214. The handrail 233 may be used by a passenger during the normal operation of the elevator system 101 to hold onto. The handrail 233 may also be used by maintenance personnel as a leverage to open the second panel 214 during maintenance operations. It will be understood that “opening” the second panel 214 refers to moving the second panel 214 from the closed position to the open position. At the same time, moving the second panel 214 from the open position to the closed position may be referred to as “closing” the second panel.

The second panel 214 may open towards the inside 207 of the elevator car 203. In the example shown, the second panel 214 is pivotably mounted to the elevator car 203. The second panel 214 may be attached to the elevator car 203 via one or more hinges (not shown). In examples, the second panel 214 may slide between the open and the closed position. In examples, the second panel 214 may be mounted to the elevator car 203 via a scissor mechanism. In examples, the second panel 214 may open in a different manner to the first panel 212.

In examples, the elevator car 203 may comprise a guide mechanism 230 to facilitate movement of the first panel 212 and/or the second panel 214 between the closed and open positions. The guide mechanism 230, or part thereof, may be provided on the first panel 212. The guide mechanism 230, or part thereof, may be provided on the second panel 214. The guide mechanism 230, or part thereof, may be provided on the floor 202 and/or ceiling 204 of the elevator car.

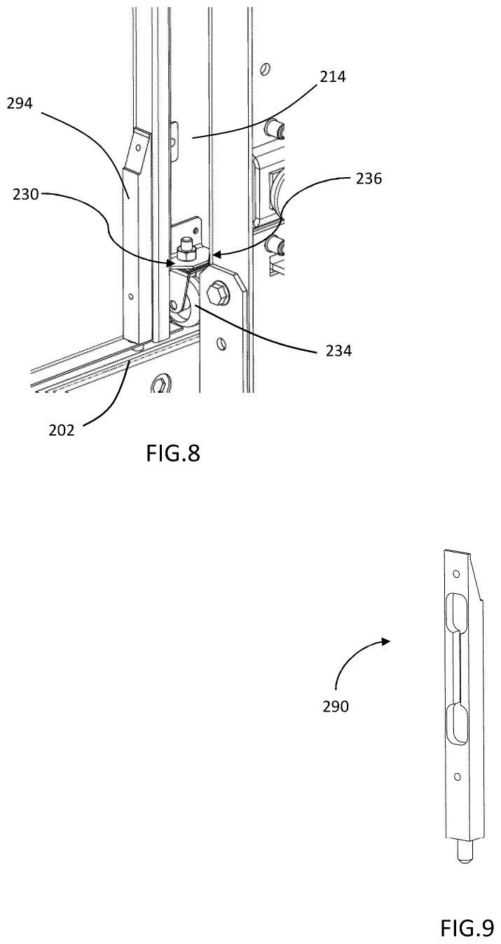

FIG. 8 is a close-up view of part of the elevator car 203 of FIG. 2 and FIG. 3, showing the guide mechanism 230. In the example shown, the guide mechanism 230 includes a roller wheel 234. The roller wheel 234 may be arranged so as to roll along the floor 202 when moving the second panel 214 between the closed and open positions. The roller wheel 234 may be attached to a bottom end 236 of the second panel 214. In other examples, the guide mechanism 230 may include a number of roller wheels, sliders and/or guide rails. In examples, the guide mechanism 230 may be provided on the first panel 212 alternatively or additionally.

The second panel 214 may be moveable from the closed position to the open position so as to provide a second opening 223 in the sidewall 210 to an area outside of the elevator car 203. The first and second panels 212, 214 may be arranged adjacent to one another. The first and second panels 212, 214 may be arranged to be in contact with one another when both of the first and second panels 212, 214 are in the closed position. The first opening 222, provided by the first panel 212, and the second opening 223, provided by the second panel 214, may overlap. The first opening 222 and the second opening 223 may define a single access window to the area 211 outside of the elevator car 203.

In other examples, the first and second panels 212, 214 may be spaced apart from one another. The first opening 222 may define a first access window to the area 211 outside of the elevator car 203 and the second opening 223 may define a second, separate access window to the area 211 outside of the elevator car 203.

The member 250 may be configured to extends across the second opening 223, provided by the second panel 214 in the sidewall 210. In the example shown, the member 250 comprises a single part. The member 250 may extend continuously across the first opening 222 and the second opening 223. In examples, a first segment of the member 250 may extend across the first opening 222 and a second segment of the member 250 may extend across the second opening 223.

The first panel 212 may be moveable independently of the second panel 214. The first panel 212 may be held in position relative to the second panel 214 by at least one interpanel mechanism 280 when both the first panel 212 and the second panel 214 are in their respective closed positions. The interpanel mechanism 280 may be configured to prevent the first and second panels 212, 214 from moving in relation to one another when in a closed state. The interpanel mechanism 280 may be configured to require a password, credentials, a key, a key card or special tooling to be opened. This may ensure that only maintenance personnel can unlock the first panel 212 from the second panel 214 so as to open the first and/or the second panel. The interpanel mechanism 280 may be operable from the inside 207 of the elevator car 203.

The first panel 212 may comprise at least one auxiliary mechanism for holding the first panel 212 in place when the first panel 212 is in the closed position. The auxiliary mechanism may be accessible from the inside 207 of the elevator car when the second panel 214 is in the open position. The auxiliary mechanism may ensure that the first panel 212 and the second panel 214 do not open suddenly and at the same time, for example once the interpanel mechanism 280 is opened.

In the example shown, the first panel comprises a first auxiliary mechanism 292 and a second auxiliary mechanism 294. The first and second auxiliary mechanisms 292, 294 may each comprise a door bolt. FIG. 9 is a close-up view of an example first auxiliary mechanism 292 for use in the elevator car 203 of FIG. 2 and FIG. 3.

The first auxiliary mechanism 292 may be configured to move from a locked position, in which the first auxiliary mechanism 292 secures the first panel 212 to the floor 202, to an unlocked position, in which the first auxiliary mechanism 292 does not secure the first panel 212 to the floor 202. A bolt or a latch of the first auxiliary mechanism 292 may extend into the floor 202 in order to secure the first panel 212 in relation to the floor 202. The floor 202 may comprise an aperture (not shown) for receiving a part of the first auxiliary mechanism 292, such as a bolt or a latch. The first auxiliary mechanism 292 may be provided proximate the floor 202 of the elevator car 203.

The second auxiliary mechanism 294 may be provided proximate the ceiling 204 of the elevator car 203. The second auxiliary mechanism 294 may be configured to move from a locked position, in which the second auxiliary mechanism 294 secures the first panel 212 to the ceiling 204, to an unlocked position, in which the second auxiliary mechanism 294 does not secure the first panel 212 to the ceiling 204. A bolt or a latch of the second auxiliary mechanism 294 may extend into the ceiling 204 in order to secure the first panel 212 in relation to the ceiling 204. The ceiling 204 may comprise an aperture (not shown) for receiving a part of the second auxiliary mechanism 294, such as a bolt or a latch. The second auxiliary mechanism 294 may be provided proximate the ceiling 204 of the elevator car 203. It will be appreciated that only one of the first and second auxiliary mechanisms 292, 294 may be provided.

The first and second auxiliary mechanisms 292, 294 may be accessible from the inside 207 of the elevator car 203 when the second panel 214 is in the open position. The first and second auxiliary mechanisms 292, 294 may be provided on a side of the first panel 212. The first and second auxiliary mechanism 292, 294 may be configured to be flush with the side of the first panel 212.

With reference to FIG. 3 and FIG. 4, the elevator car 103 may comprise a control panel 240. The control panel 240 may be provided on the inside 207 of the elevator car 203. The control panel 240 may comprise a first passenger facing side 241 and a second side 242. The second side 242 may be opposite of the first side. The second opposite side 242 may comprise a back side or a rear of the control panel 240. Various component parts of the control panel 240 may be accessible from the second side 242. The control panel 240 may housed within, or otherwise integrated with, one of the first panel 212 and the second panel 214. In other words, the control panel 240 may be attached to and moved with one of the first panel 212 and the second panel 214. Access to the second side 242 of the control panel 240 may be provided by moving one of the first and the second panels 212, 214 to the open position. Access to the second side 243 may be provided to allow for maintenance of the control panel 240. This facilitates checking, maintaining and/or repairing the control panel 240. In the example shown, the control panel 240 is housed in the second panel 214. Access to the second side 242 of the control panel 240 may be provided by moving the second panel 214 from the closed position to the open position. In examples, it may not be necessary to open the first panel 212 in order to gain access to the second side 242 of the control panel 240. The first panel 212 may be locked into place in the closed position via the mechanism 270 so as to minimise the number (and/or size) of the openings provided in the sidewall 210 during work being carried out on the second side 242 of the control panel 240.

As described above, in examples the elevator car 203 may comprise a number of additional members. Any number of the additional members may further comprise a respective mechanism 270 as described above.

While the disclosure has been described in relation to the sidewall 210 comprising a first and a second panel 212, 214, it will be understood that the disclosure is not limited to this. In examples, the sidewall 320 may comprise only the first panel 212. In such examples, the mechanism 270 may be remotely operated.

Further, while the disclosure has been described in relation to the mechanism 270 being provided on the first panel 212, it will be appreciated that a further mechanism may be provided on the second panel 214. Alternatively, a further mechanism may be provided on the member 250 and configured to engage with the second panel 214 when the mechanism 270 is in the locked position. In examples comprising a plurality of mechanisms, one or more of the mechanisms may be operated remotely.

A method of providing access to an area 211 outside an elevator car, for example for checking, maintaining or repairing an elevator system, such as the elevator system 101 comprising the elevator car 203, is provided. The method includes operating the mechanism 270 to move the mechanism 270 from the second position to the first position. The method further includes moving the first panel 212 from the closed position to the open position such that access to component parts located outside the elevator car 203 is provided from the inside 207 of the elevator car 203.

In examples where the elevator car 203 comprises the second panel 214, the method may include moving the second panel 214 from the closed position to the open position such that access to the mechanism 270 is provided from the inside 207 of the elevator car 203. The method may include moving the second panel 214 to the open position before operating the mechanism 270. Operating the mechanism 270 may further comprise accessing the mechanism 270 via the second opening 223 to manually move the mechanism 270 from the second position to the first position.

The method may include operating an interpanel mechanism 280 so as to release the second panel 214 in relation to the first panel 212.

It will be appreciated by those skilled in the art that the disclosure has been illustrated by describing one or more examples thereof, but is not limited to these examples; many variations and modifications are possible, within the scope of the accompanying claims. For example, the elevator car may be used in a roped or ropeless elevator system, or another type of conveyance system.

1. An elevator car comprising:
a panel moveable between a closed position, in which the panel at least partially defines a sidewall of the elevator car, and an open position, in which an opening is provided in the sidewall to an area outside of the elevator car;
a member provided external to the sidewall and extending across at least a portion of the sidewall such that, when the panel is in the open position, the opening provided in the sidewall is spanned by the member; and
a mechanism provided on one of the panel and the member,
wherein the mechanism is configured to be moveable between a first position, in which the mechanism is not engaged with the other one of the panel and the member or with a component attached to the other one of the panel and the member, and a second position, in which the mechanism is engaged with the other one of the panel and the member or with the component attached to the other one of the panel and the member such that the panel is held in the closed position.

2. The elevator car of claim 1, further comprising at least one additional member.

3. The elevator car of claim 2, wherein the member or the at least one additional member is configured to stop maintenance personnel falling from the elevator car when accessing the area outside of the elevator car.

4. The elevator car of any of claim 2, wherein the member or the at least one additional member is provided proximate a floor of the elevator car.

5. The elevator car of claim 1, wherein the mechanism comprises at least one of a hook or a latch configured to fasten the member and the panel to one another when the mechanism is in the second position.

6. The elevator car of claim 1, wherein the mechanism is configured to pivot between the first position and the second position, and/or wherein the mechanism is moveable manually between the first position and the second position.

7. The elevator car of claim 1, wherein the panel is a first panel and the opening is a first opening, wherein the elevator car further comprises:
a second panel moveable between a closed position, in which the second panel at least partially defines the sidewall of the elevator car, and an open position, in which a second opening is provided in the sidewall to the area outside of the elevator car.

8. The elevator car of claim 7, further comprising an auxiliary mechanism configured to secure the first panel in the closed position.

9. The elevator car of claim 8, wherein the auxiliary mechanism is configured to secure the first panel to at least one of a floor or a ceiling (204) of the elevator car, and/or wherein the auxiliary mechanism comprises at least one of a door bolt or a latch.

10. The elevator car of claim 7, further comprising an interpanel mechanism configured to secure the first panel to the second panel when both the first panel and the second panel are in the closed position.

11. The elevator car of claim 7, wherein a control panel of the elevator car comprises a first passenger facing side and a second opposite side, and wherein the control panel is integrated within one of the first panel and the second panel such that when the first panel or the second panel (212, 214) is in the open position, access is provided to the second opposite side of the control panel.

12. An elevator system comprising the elevator car according to claim 1.

13. A method of providing access to the area outside the elevator car as claimed in claim 1, wherein the method includes:
operating the mechanism to move the mechanism from the second position to the first position; and
moving the panel from the closed position to the open position to provide the opening via which component parts located outside the elevator car are accessible from inside of the elevator car.

14. The method of claim 13, wherein the panel is a first panel and the opening is a first opening, and wherein the elevator car further comprises a second panel moveable between a closed position, in which the second panel at least partially defines the sidewall of the elevator car, and an open position, in which a second opening is provided in the sidewall to the area outside of the elevator car,
the method further comprising:
before operating the mechanism, moving the second panel to the open position.

15. The method of claim 14, wherein operating the mechanism comprises accessing the mechanism via the second opening to manually move the mechanism from the second position to the first position.

16. The elevator car of claim 4, wherein the member or the at least one additional member comprises a kickplate.
